(19) United States
(12) Patent Application Publication
(10) Pub. No.: US 2007/0051773 A1
(43) Pub. Date: Mar. 8, 2007

(54) Thermal interface materials, methods of preparation thereof and their applications

(76) Inventors: Brian D. Ruchert, Newman Lake, WA (US); James P. Flint, Mead, WA (US); Richard G. Townsend, Post Falls, ID (US)

Correspondence Address: Buchalter Nemer;A Professional Corporation, Suite 800, 18400 Von Karman, Irvine, CA, 92612, US

(21) Appl. No.: 11/218,973

(22) Filed: Sep. 2, 2005

(51) Int. Cl. A47J 36/02

(52) U.S. Cl. 228/101

(57) ABSTRACT

Thermal interface materials are described herein that include at least one phase change material, and at least one solvent, solvent mixture or combination thereof, wherein the at least one solvent, solvent mixture or combination thereof at least partially solvates the at least one phase change material. Methods of producing thermal interface materials are also described that include providing at least one phase change material; providing at least one solvent, solvent mixture or combination thereof, wherein the at least one solvent, solvent mixture or combination thereof at least partially solvates the at least one phase change material; and physically coupling the at least one phase change material and the at least one solvent, solvent mixture or combination thereof.

### FIELD OF THE INVENTION

The field of the invention is thermal interface materials in electronic components, semiconductor components and other related layered materials applications.

### BACKGROUND

Electronic components are used in ever increasing numbers of consumer and commercial electronic products. Examples of some of these consumer and commercial products are televisions, personal computers, internet servers, cell phones, pagers, palm-type organizers, portable radios, car stereos or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads and chip packaging.

Components, therefore, are being broken down and investigated to determine if there are better compositions, materials and methods that will allow them to be scaled down to accommodate the demands for smaller electronic and semiconductor components. In layered components, one goal appears to be decreasing the number of the layers and/or the thickness of layers while at the same time increasing the functionality and durability of the remaining layers. This task can be difficult, however, given that several of the layers and components of the layers should generally be present in order to operate the device.

Also, as electronic devices become smaller and operate at higher speeds, energy emitted in the form of heat increases dramatically. A popular practice in the industry is to use thermal grease, or grease-like materials, alone or on a carrier in such devices to transfer the excess heat dissipated across physical interfaces. Most common types of thermal interface materials are thermal greases, phase change materials, and elastomer tapes. Thermal greases or phase change materials have lower thermal resistance than elastomer tape because of the ability to be spread in thin layers and provide intimate contact between adjacent surfaces. Typical thermal impedance values range between 0.6-1.6° C. cm²/w. However, a serious drawback of thermal grease is that thermal performance deteriorates significantly after thermal cycling, such as from 65° C. to 150° C., or after power cycling when used in VLSI chips. It has also been found that the performance of these materials deteriorates when large deviations from surface planarity causes gaps to form between the mating surfaces in the electronic devices or when large gaps between mating surfaces are present for other reasons, such as manufacturing tolerances, etc. When the heat transferability of these materials breaks down, the performance of the electronic device in which they are used is adversely affected.

Thus, there is a continuing need to: a) design and produce thermal interface materials and layered materials that meet customer specifications while minimizing the size of the device and number of layers; b) produce more efficient and better designed materials and/or components with respect to the compatibility requirements of the material, component or finished product; c) develop reliable methods of producing desired thermal interface materials and layered materials and components comprising contemplated thermal interface and layered materials; and d) develop thermal interface materials that can be “printed” or otherwise applied to surfaces in order to achieve a thinner bond line than conventional layered materials that comprise thermal interface materials.

### SUMMARY

Thermal interface materials are described herein that include at least one phase change material, and at least one solvent, solvent mixture or combination thereof, wherein the at least one solvent, solvent mixture or combination thereof at least partially solvates the at least one phase change material.

Methods of producing thermal interface materials are also described that include providing at least one phase change material; providing at least one solvent, solvent mixture or combination thereof, wherein the at least one solvent, solvent mixture or combination thereof at least partially solvates the at least one phase change material; and physically coupling the at least one phase change material and the at least one solvent, solvent mixture or combination thereof.

Various objects, features, aspects and advantages of the present invention will become more apparent from the following detailed description of preferred embodiments of the invention.

### DETAILED DESCRIPTION

A suitable thermal interface material or component should conform to the mating surfaces (“wets” the surface), possess a low bulk thermal resistance and possess a low contact resistance. Bulk thermal resistance can be expressed as a function of the material's or component's thickness, thermal conductivity and area. Contact resistance is a measure of how well a material or component is able to make contact with a mating surface, layer or substrate. The thermal resistance of an interface material or component can be shown as follows:
Θinterface=t/kA+2Θ_{contact} Equation 1
where
   Θ is the thermal resistance,
   t is the material thickness,
   k is the thermal conductivity of the material
   A is the area of the interface

The term “t/kA” represents the thermal resistance of the bulk material and “2Θ_{contact}” represents the thermal contact resistance at the two surfaces. A suitable interface material or component should have a low bulk resistance and a low contact resistance, i.e. at the mating surface.

Many electronic and semiconductor applications require that the thermal interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. As the thermal performance drops, package performance will decrease to an unacceptable level. Also, for such applications, differences in CTE between the mating components causes the gap to expand and contract with each temperature or power cycle. This variation of the interface thickness can cause pumping of fluid interface materials (such as grease) away from the interface.

Interfaces with a larger area are more prone to deviations from surface planarity as manufactured. To optimize thermal performance, the thermal interface material should be able to conform to non-planar surfaces and thereby lower contact resistance.

Optimal thermal interface materials and/or components possess a high thermal conductivity and a high mechanical compliance, e.g. will yield elastically when force is applied. High thermal conductivity reduces the first term of Equation 1 while high mechanical compliance reduces the second term. The layered interface materials and the individual components of the layered interface materials described herein accomplish these goals.

In response to the problems with conventional materials, as described herein, thermal interface materials and phase change materials have been designed and produced that: a) meet customer specifications while minimizing the size of the device and number of layers; b) are more efficient and better designed with respect to the compatibility requirements of the material, component or finished product; c) are produced by more reliable methods than conventional materials; and d) that can be “printed” or otherwise applied to surfaces in order to achieve a thinner bond line than conventional layered materials that comprise conventional thermal interface materials.

Thermal interface materials, as contemplated herein, may comprise up to 100% of a phase change material. For example, a contemplated thermal interface material may comprise 100% of a phase change material or may comprise less of a percentage of a phase change material and more of a percentage of at least one crosslinkable and/or compliant composition, and/or at least one thermal interface composition, such as those disclosed in PCT Publication Nos.: WO 02/96636, WO 04/022330 and WO 02/061764; PCT Serial No.: PCT/US02/25447; U.S. Ser. Nos.: 10/465,968, 11/156,698; U.S. Pat. Nos. 6,451,422, 6,673,434, 6,797,382, 6,908,669, 6,238,596, 6,605,238, 6,811,725 and 5,989,459, which are all commonly owned by Honeywell International Inc. and incorporated herein by reference in their entirety. Thermal interface materials, as contemplated herein, may also comprise polymer solder materials, such as those disclosed in U.S. Issued Pat. No. 6,706,219 and U.S. Pending application Ser. No. 10/775,989, which are both commonly owned by Honeywell and incorporated herein in their entirety by reference. Therefore, thermal interface materials are contemplated herein that comprise phase change materials, as described herein, in an amount of greater than 0 weight percent up to about 100 weight percent of phase change material. In other words, in each of the thermal interface materials contemplated herein, there should be at least some amount of phase change material. It should be understood also that there will be a solvent, solvent mixture or combination of solvents mixed in with the at least one phase change material.

The amount of phase change material that is necessary in a thermal interface material composition depends primarily on the needs of the component or product. Specifically, if the needs of the component or product require that the composition or interface material be in a “soft gel” form or a somewhat liquid form, then a large amount of phase change material may not need to be added. However, if the component, layered material or product requires that the composition or material be more like a solid, then more phase change material should be added.

Phase-change materials that are contemplated herein comprise waxes, polymer waxes or mixtures thereof, such as paraffin wax. Paraffin waxes are a mixture of solid hydrocarbons having the general formula CₙH₂ₙ₊₂ and having melting points in the range of about 20° C. to 100° C. Examples of some contemplated melting points are about 45° C. and 60° C. Phase change materials that have melting points in this range are PCM45 and PCM60HD—both manufactured by Honeywell International Inc. Polymer waxes are typically polyethylene waxes, polypropylene waxes, and have a range of melting points from about 40° C. to 160° C.

PCM45 comprises a thermal conductivity of about 3.0 W/mK, a thermal resistance of about 0.25° C.cm²/W (0.0038° C.cm²/W), is typically applied at a thickness of about 0.0015 inches (0.04 mm) and comprises a typical softness of about 5 to 30 psi (plastically flow under). Typical characteristics of PCM45 are a) a super high packaging density—over 80%, b) a conductive filler, c) extremely low thermal resistance, and as mentioned earlier d) about a 45° phase change temperature. PCM60HD comprises a thermal conductivity of about 5.0 W/mK, a thermal resistance of about 0.17° C.cm²/W (0.0028° C.cm²/W), is typically applied at a thickness of about 0.0015 inches (0.04 mm) and comprises a typical softness of about 5 to 30 psi (plastically flow under). Typical characteristics of PCM45 are a) a super high packaging density—over 80%, b) a conductive filler, c) extremely low thermal resistance, and as mentioned earlier d) about a 60° phase change temperature.

TM350 (a thermal interface material not comprising a phase change material and manufactured by Honeywell International Inc.) comprises a thermal conductivity of about 3.0 W/mK, a thermal resistance of about 0.25° C.cm²/W (0.0038° C.cm²/W), is typically applied at a thickness of about 0.0015 inches (0.04 mm) and comprises a typical softness of about 5 to 30 psi (plastically flow under). Typical characteristics of TM350 are a) a super high packaging density—over 80%, b) a conductive filler, c) extremely low thermal resistance, d) about a 125° curing temperature, and e) dispensable non-silicone-based thermal gel. TM350 is considered for a thermal interface composition as used in contemplated embodiments described herein.

Phase change materials are useful in thermal interface material applications because they store and release heat as they oscillate between solid and liquid form. As a phase change material changes to a solid state, it gives off heat. As it returns to a liquid, it absorbs heat. The phase change temperature is the melting temperature at which the heat absorption and rejection takes place.

A solvent, solvent mixture, an additional solvent or a combination thereof is added to the phase change material, thermal interface composition and/or thermal interface material in order to a) alter the physical or electronic properties of the material to the specifications of the component or components in which the material will be applied; b) alter the physical properties of the material in order to facilitate application of the material; and/or c) facilitate incorporation of other constituents or fillers into the material. Contemplated solvents include any suitable pure or mixture of organic or inorganic molecules that are volatilized at a desired temperature, such as the critical temperature, or that can facilitate any of the above-mentioned design goals or needs. In addition, contemplated solvents are those solvents that are compatible with the phase change materials, in that they will interact with the phase change materials to achieve the previously-mentioned goals. In some embodiments, the solvent, solvent mixture or combination thereof will solvate the phase change material such that it can be applied by printing techniques. The solvent, solvent mixture or combination thereof may also comprise any suitable pure or mixture of polar and non-polar compounds. As used herein, the term “pure” means that solvent constituent that has a constant composition. For example, pure water is composed solely of H₂O. As used herein, the term “mixture” means that solvent constituent that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound.

In some contemplated embodiments, the solvent, solvent mixture (comprising at least two solvents) or combination thereof comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, Isopar H and other paraffin oils, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, paraffin oils, benzene, toluene, xylene and mixtures or combinations thereof.

In other contemplated embodiments, the solvent or solvent mixture may comprise those solvents that are not considered part of the hydrocarbon solvent family of compounds, such as ketones, such as acetone, diethyl ketone, methyl ethyl ketone and the like, alcohols, esters, ethers and amines. In yet other contemplated embodiments, the solvent or solvent mixture may comprise a combination of any of the solvents mentioned herein.

In thermal interface materials contemplated herein, the solvent, solvent mixture or combination thereof will be present in a weight percent that is appropriate for the phase change material and also for the thermal interface composition and/or thermal interface material. In one embodiment, a solvent such as Isopar H can be present in an amount less than about 40 weight percent. In another embodiment, Isopar H can be present in an amount less than about 20 weight percent. In yet other embodiments, Isopar H can be present in an amount of less than about 10 weight percent. This example should exemplify how solvents may be utilized in embodiments disclosed herein.

One example of a thermal interface material that comprises both a phase change material and a thermal interface composition is a rubber-resin modified paraffin polymer wax system, such as some of the contemplated embodiments described herein. Paraffin-based phase change materials, on their own, can be very fragile and difficult to handle. They also tend to squeeze out of a gap from the device in which they are applied during thermal cycling, very much like grease. A combination of phase change material and other “non-phase change material” thermal interface compositions avoids these problems and provides significantly improved ease of handling, is capable of being produced in flexible tape or solid layer form, and does not pump out or exude under pressure. Although the rubber-resin-wax mixtures may have the same or nearly the same temperature, their melt viscosity is much higher and they do not migrate easily. Moreover, the rubber-wax-resin mixture can be designed to be self-crosslinking, which ensures elimination of the pump-out problem in certain applications. Examples of contemplated phase change materials are malenized paraffin wax, polyethylene-maleic anhydride wax, and polypropylene-maleic anhydride wax. The rubber-resin-wax mixtures will functionally form at a temperature between about 50 to 150° C. to form a crosslinked rubber-resin network.

One contemplated crosslinkable thermal interface composition is produced by combining at least one rubber compound, at least one amine resin and at least one thermally conductive filler. This contemplated thermal interface composition takes on the form of a liquid or “soft gel”. As used herein, “soft gel” means a colloid in which the disperse phase has combined with the continuous phase to form a viscous “jelly-like” product. The gel state or soft gel state of the thermal interface composition is brought about through a crosslinking reaction between the at least one rubber compound composition and the at least one amine resin composition. More specifically, the amine resin is incorporated into the rubber composition to crosslink the primary hydroxyl groups on the rubber compounds, thus forming the soft gel phase. Therefore, it is contemplated that at least some of the rubber compounds will comprise at least one terminal hydroxyl group. As used herein, the phrase “hydroxyl group” means the univalent group —OH occurring in many inorganic and organic compounds that ionize in solution to yield OH radicals. Also, the “hydroxyl group” is the characteristic group of alcohols. As used herein, the phrase “primary hydroxyl groups” means that the hydroxyl groups are in the terminal position on the molecule or compound. Rubber compounds contemplated herein may also comprise additional secondary, tertiary, or otherwise internal hydroxyl groups that could also undergo a crosslinking reaction with the amine resin. This additional crosslinking may be desirable depending on the final gel state needed for the product or component in which the gel is to be incorporated.

It is contemplated that the rubber compounds could be “self-crosslinkable” in that they could crosslink intermolecularly with other rubber compounds or intramolecularly with themselves, depending on the other components of the composition. It is also contemplated that the rubber compounds could be crosslinked by the amine resin compounds and perform some self-crosslinking activity with themselves or other rubber compounds.

In preferred embodiments, the rubber compositions or compounds utilized can be either saturated or unsaturated. Saturated rubber compounds are preferred in this application because they are less sensitive to thermal oxidation degradation. Examples of saturated rubbers that may be used are ethylene-propylene rubbers (EPR, EPDM), polyethylene/butylene, polyethylene-butylene-styrene, polyethylene-propylene-styrene, hydrogenated polyalkyldiene “mono-ols” (such as hydrogenated polybutadiene mono-ol, hydrogenated polypropadiene mono-ol, hydrogenated polypentadiene mono-ol), hydrogenated polyalkyldiene “diols” (such as hydrogenated polybutadiene diol, hydrogenated polypropadiene diol, hydrogenated polypentadiene diol) and hydrogenated polyisoprene. However, if the compound is unsaturated, it is most preferred that the compound undergo a hydrogenation process to rupture or remove at least some of the double bonds. As used herein, the phrase “hydrogenation process” means that an unsaturated organic compound is reacted with hydrogen by either a direct addition of hydrogen to some or all of the double bonds, resulting in a saturated product (addition hydrogenation), or by rupturing the double bond entirely, whereby the fragments further react with hydrogen (hydrogenolysis). Examples of unsaturated rubbers and rubber compounds are polybutadiene, polyisoprene, polystyrene-butadiene and other unsaturated rubbers, rubber compounds or mixtures/combinations of rubber compounds.

As used herein, the term “compliant” encompasses the property of a material or a component that is yielding and formable, especially at about room temperature, as opposed to solid and unyielding at room temperature. As used herein, the term “crosslinkable” refers to those materials or compounds that are not yet crosslinked.

As used herein, the term “crosslinking” refers to a process in which at least two molecules, or two portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

More than one rubber compound of each type may be combined to produce a crosslinkable thermal interface composition; however, it is contemplated that in these thermal interface compositions, at least one of the rubber compounds or constituents will be a saturated compound. Olefin-containing or unsaturated thermal interface materials, with appropriate thermal fillers, exhibit a thermal capability of less than 0.5 cm²° C./w. Unlike thermal grease, thermal performance of the thermal interface composition will not degrade after thermal cycling or flow cycling in IC devices because liquid olefins and liquid olefin mixtures (such as those comprising amine resins) will crosslink to form a soft gel upon heat activation. Moreover, when applied as a thermal interface material, it will not be “squeezed out” as thermal grease does in use and will not display interfacial delamination during thermal cycling.

Amine or amine-based resins are added or incorporated into the rubber composition or mixture of rubber compounds primarily to facilitate a crosslinking reaction between the amine resin and the primary or terminal hydroxyl groups on at least one of the rubber compounds. The crosslinking reaction between the amine resin and the rubber compounds produces a “soft gel” phase in the mixture, instead of a liquid state. The degree of crosslinking between the amine resin and the rubber composition and/or between the rubber compounds themselves will determine the consistency of the soft gel. For example, if the amine resin and the rubber compounds undergo a minimal amount of crosslinking (10% of the sites available for crosslinking are actually used in the crosslinking reaction) then the soft gel will be more “liquid-like”. However, if the amine resin and the rubber compounds undergo a significant amount of crosslinking (40-60% of the sites available for crosslinking are actually used in the crosslinking reaction and possibly there is a measurable degree of intermolecular or intramolecular crosslinking between the rubber compounds themselves) then the gel would become thicker and more “solid-like”.

Amine and amino resins are those resins that comprise at least one amine substituent group on any part of the resin backbone. Amine and amino resins are also synthetic resins derived from the reaction of urea, thiourea, melamine or allied compounds with aldehydes, particularly formaldehyde. Typical and contemplated amine resins are primary amine resins, secondary amine resins, tertiary amine resins, glycidyl amine epoxy resins, alkoxybenzyl amine resins, epoxy amine resins, melamine resins, alkylated melamine resins, and melamine-acrylic resins. Melamine resins are particularly useful and preferred in several contemplated embodiments described herein because a) they are ring-based compounds, whereby the ring contains three carbon and three nitrogen atoms, b) they can combine easily with other compounds and molecules through condensation reactions, c) they can react with other molecules and compounds to facilitate chain growth and crosslinking, d) they are more water resistant and heat resistant than urea resins, e) they can be used as water-soluble syrups or as insoluble powders dispersible in water, and f) they have high melting points (greater than 325° C. and are relatively non-flammable). Alkylated melamine resins, such as butylated melamine resins, propylated melamine resins, pentylated melamine resins hexylated melamine resins and the like, are formed by incorporating alkyl alcohols during the resin formation. These resins are soluble in paint and enamel solvents and in surface coatings.

Thermal filler particles to be dispersed in the thermal interface material or mixture should advantageously have a high thermal conductivity. Suitable filler materials include metals, such as silver, copper, aluminum, and alloys thereof; and other compounds, such as boron nitride, aluminum nitride, silver coated copper, silver-coated aluminum, conductive polymers and carbon fibers. Combinations of boron nitride and silver or boron nitride and silver/copper also provide enhanced thermal conductivity. Boron nitride in amounts of at least 20 wt % and silver in amounts of at least about 60 wt % are particularly useful. Preferably, fillers with a thermal conductivity of greater than about 20 and most preferably at least about 40 w/m° C. can be used. Optimally, it is desired to have a filler of not less than about 80 w/m° C. thermal conductivity.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include indium, silver, copper, aluminum, tin, bismuth, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes.

It is also advantageous to incorporate additional fillers, substances or particles, such as filler particles, wetting agents or antioxidants into the thermal interface material. Substantially spherical filler particles can be added to the thermal interface material to maximize packing density. Additionally, substantially spherical shapes or the like will provide some control of the thickness during compaction. Typical particle sizes useful for fillers in the rubber material may be in the range of about 1-20 μm with a maximum of about 100 μm.

Dispersion of filler particles can be facilitated by addition of functional organometallic coupling agents or “wetting” agents, such as organosilane, organotitanate, organozirconium, etc. Organotitanate acts a wetting enhancer to reduce paste viscosity and to increase filler loading. An organotitanate that can be used is isopropyl triisostearyl titanate. The general structure of organotitanate is RO-Ti(OXRY) where RO is a hydrolyzable group, and X and Y are binder functional groups.

Antioxidants may also be added to inhibit oxidation and thermal degradation of the cured rubber gel or solid thermal interface material. Typical useful antioxidants include Irganox 1076, a phenol type or Irganox 565, an amine type, (at 0.01% to about 1 wt. %), available from Ciba Giegy of Hawthorne, N.Y. Typical cure accelerators include tertiary amines such as didecylanethylamine, (at 50 ppm—0.5 wt. %).

At least one catalyst may also be added to the thermal interface composition and/or the thermal interface material in order to promote a crosslinking or chain reaction between some or all of the components of the thermal interface material. As used herein, the term “catalyst” means that substance or condition that notably affects the rate of a chemical reaction without itself being consumed or undergoing a chemical change. Catalysts may be inorganic, organic, or a combination of organic groups and metal halides. Although they are not substances, light and heat can also act as catalysts. In contemplated embodiments, the catalyst is an acid. In preferred embodiments, the catalyst is an organic acid, such as carboxylic, acetic, formic, benzoic, salicylic, dicarboxylic, oxalic, phthalic, sebacic, adipic, oleic, palmitic, stearic, phenylstearic, amino acids and sulfonic acid.

Of special efficacy is a filler comprising a particular form of carbon fiber referred to as “vapor grown carbon fiber” (VGCF), such as is available from Applied Sciences, Inc., Cedarville, Ohio. VGCF, or “carbon micro fibers”, are highly graphized types by heat treatment (thermal conductivity=1900 w/m° C.). Addition of about 0.5 wt. % carbon micro fibers provides significantly increased thermal conductivity. Such fibers are available in varying lengths and diameters; namely, 1 millimeter (mm) to tens of centimeters (cm) length and from under 0.1 to over 100 μm in diameter. One useful form of VGCF has a diameter of not greater than about 1 μm and a length of about 50 to 100 μm, and possess a thermal conductivity of about two or three times greater than with other common carbon fibers having diameters greater than 5 μm.

It is difficult to incorporate large amounts of VGCF in polymer systems and interface components and systems. When carbon microfibers, e.g. (about 1 μm, or less) are added to the polymer they do not mix well, primarily because a large amount of fiber must be added to the polymer to obtain any significant beneficial improvement in thermal conductivity. However, we have discovered and have disclosed in previously-filed applications that relatively large amounts of carbon microfibers can be added to polymer systems that have relatively large amounts of other conventional fillers. A greater amount of carbon microfibers can be added to the polymer when added with other fibers, which can be added alone to the polymer, thus providing a greater benefit with respect to improving thermal conductivity of the thermal interface material. Desirably, the ratio of carbon microfibers to polymer is in the range of 0.05 to 0.50 by weight.

The contemplated thermal interface materials, phase change materials and/or thermal interface compositions can be provided as a dispensable liquid paste, soft gel or liquid material to be applied by dispensing methods, such as by screen printing, ink jet printing, thread dispensing; spraying; stamping; all types of lithography or wet offset; roller printing; letter press printing; gravure printing; flexographic printing; planographic printing; offset printing; mimeo graphic printing; thermography; hot stamping and transfer printing techniques; as well as brushing and stenciling techniques. In short, any printing or dispensing process that can incorporate a paste, liquid and/or soft gel product or material can be employed effectively with embodiments of the present teachings. The dispensable liquid paste can then be cured as desired. It should also be understood that the “dispensed layer” can be laid down as a continuous layer or a patterned layer depending on the needs of the component. These layers can also be laid down as a continuous layer and then etched back to form a patterned layer. The ability of these thermal interface materials, phase change materials and thermal interface compositions to be “printed” or otherwise applied to surfaces in order to achieve a thinner bond line than conventional layered materials that comprise thermal interface materials meets at least one of the goals presented earlier.

Contemplated thermal interface materials can also be provided as a highly compliant, cured, elastomer film or sheet for pre-application on interface surfaces, such as heat sinks. It can further be provided and produced as a soft gel or liquid that can be applied to surfaces by any suitable dispensing method, including those previously mentioned. Even further, the material can be provided as a tape that can be applied directly to interface surfaces or electronic components.

Applications of the contemplated thermal interface compositions, thermal interface materials, layered interface materials and phase change materials described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

Thus, specific embodiments and applications of thermal interface materials have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A thermal interface material, comprising:
at least one phase change material, and
at least one solvent, solvent mixture or combination thereof, wherein the at least one solvent, solvent mixture or combination thereof at least partially solvates the at least one phase change material.

2. The thermal interface material of claim 1, further comprising at least one additional component.

3. The thermal interface material of claim 2, wherein the at least one additional component comprises a thermal interface composition.

4. The thermal interface material of claim 1, wherein the at least one phase change material has a melting point of about 40 to about 160° C.

5. The thermal interface material of claim 1, wherein the at least one phase change material comprises paraffin waxes, polymer waxes or a combination thereof.

6. The thermal interface material of claim 5, wherein the at least one polymer wax comprises polyethylene waxes, polypropylene waxes or a combination thereof.

7. The thermal interface material of claim 1, wherein the at least one solvent or solvent mixture comprises at least one hydrocarbon compound.

8. The thermal interface material of claim 7, wherein the at least one hydrocarbon compound comprises Isopar H.

9. A layered component comprising the thermal interface material of claim 1.

10. An electronic component comprising the thermal interface material of claim 1.

11. A layered component comprising the thermal interface material of claim 2.

12. An electronic component comprising the thermal interface material of claim 2.

13. A tape comprising the thermal interface material of claim 3.

14. A layer of the thermal interface material of claim 1, wherein the layer has been printed onto a surface or substrate.

15. The layer of claim 14, wherein the layer is a continuous layer.

16. The layer of claim 14, wherein the layer is a patterned layer.

17. The layer of claim 14, wherein the layer is printed onto a surface or substrate by using a printing device or by screen printing.

18. The layer of claim 17, wherein the printing device is an ink-jet printer.

19. A method of producing a thermal interface material, comprising:
providing at least one phase change material;
providing at least one solvent, solvent mixture or combination thereof, wherein the at least one solvent, solvent mixture or combination thereof at least partially solvates the at least one phase change material; and
physically coupling the at least one phase change material and the at least one solvent, solvent mixture or combination thereof.

20. The method of claim 19, further comprising providing at least one additional component and physically coupling the at least one additional component with the at least one phase change material and the at least one solvent, solvent mixture or combination thereof.

21. The method of claim 20, wherein the at least one additional component comprises a thermal interface composition.

22. The method of claim 19, wherein the at least one phase change material has a melting point of about 40 to about 160° C.

23. The method of claim 19, wherein the at least one phase change material comprises paraffin waxes, polymer waxes or a combination thereof.

24. The method of claim 23, wherein the at least one polymer wax comprises polyethylene waxes, polypropylene waxes or a combination thereof.

25. The method of claim 19, wherein the at least one solvent or solvent mixture comprises at least one hydrocarbon compound.

26. The method of claim 25, wherein the at least one hydrocarbon compound comprises Isopar H.
